(19) United States
(12) Patent Application Publication
(10) Pub. No.: US 2014/0079518 A1
(43) Pub. Date: Mar. 20, 2014

(54) Stacking Crane System and the Stacking Crane Thereof

(71) Applicant: Shenzhen China Star Optoelectronics Technology Co., Ltd., Shenzhen, Guangdong (CN)

(72) Inventors: Minghu Qi, Shenzhen City (CN); Chunhao Wu, Shenzhen City (CN); Kunhsien Lin, Shenzhen City (CN); Yongqiang Wang, Shenzhen City (CN); Zhenhua Guo, Shenzhen City (CN); Weibing Yang, Shenzhen City (CN); Zenghong Chen, Shenzhen City (CN); Yunshao Jiang, Shenzhen City (CN); Zhiyou Shu, Shenzhen City (CN)

(73) Assignee: Shenzhen China Star Optoelectronics Technology Co., Ltd., Shenzhen, Guangdong (CN)

(21) Appl. No.: 13/642,538

(22) PCT Filed: Sep. 24, 2012
(86) PCT No.: PCT/CN2012/081849

§ 371 Date: Oct. 21, 2012

(30) Foreign Application Priority Data
Sep. 19, 2012 (CN) 201210349124.1

(51) Int. Cl. B66F 9/065; B65G 1/04

(52) U.S. Cl. CPC B66F 9/065; B65G 1/0407
USPC 414/632

(57) ABSTRACT

A stacking crane moving along a first horizontal direction is disclosed. The stacking crane includes a lifting assembly, a rotating assembly, an extendable assembly, and a fork. The lifting assembly controls the extendable assembly and the fork to move along a vertical direction and the rotating assembly rotates the extendable assembly and the fork along a horizontal surface so that the extendable assembly controls the fork to move at least along the first horizontal direction and along a second horizontal direction to access objects. In addition, a stacking crane system including two stacking cranes is disclosed. The stacking cranes may transfer the objects to each other directly.

### BACKGROUND OF THE INVENTION

1. Field of the Invention

Embodiments of the present disclosure relate to warehouse technology, and more particularly to a stacking crane system and the stacking crane thereof. 2. Discussion of the Related Art

In a manufacturing process of liquid crystal devices, glass substrates are usually temporarily stored in cartridges by automation warehouse system. The automation warehouse system includes at least two rows of racks and stacking cranes arranged in a tunnel between two racks.

Usually, the stacking crane accesses the cartridges in a first location and transfer the cartridges to a second location of the rack. The conventional stacking cranes include two pillars, two lifting assemblies arranged on two pillars, a supporting platform, a fork and a moving assembly. The supporting platform connects with the two lifting assemblies. The height of the supporting platform is adjusted by the lifting assemblies. The fork connects with the supporting platform and is capable of extending and rotating with respect to the supporting platform. The moving assembly connects to bottoms of the pillars to control the stacking crane to move in a central line between two racks. The stacking cranes are capable of accessing the glass substrates arranged in the racks.

As the tunnel between the two racks is long, it may take a long time to access the glass substrate if only one stacking crane is adopted to perform the glass substrate transportation. Thus, the transporting efficiency is low.

In order to solve the above problems, two stacking cranes may be adopted so that the transporting time of the glass substrate is decreased. However, the forks of the conventional stacking cranes are only capable of accessing glass substrates along a direction vertical to the two pillars. Thus, a public area has to be arranged on the rack while two stacking cranes are adopted, wherein one stacking crane has to transfer the glass substrate to the public area, and the other stacking crane has to move the glass substrate away from the public area. The public area reduces the capacity of the warehouse.

### SUMMARY

The object of the claimed invention is to provide a stacking crane system and the stacking crane thereof to enhance the transporting efficiency and a warehouse capacity.

In one aspect, a stacking crane moves along a first horizontal direction. The stacking crane includes as lifting assembly, a rotating assembly, an extendable assembly, and a fork. The lifting assembly controls the extendable assembly and the fork to move along a vertical direction, and the rotating assembly rotates the extendable assembly and the fork. along a horizontal surface so that the extendable assembly controls the fork to move at least along the first horizontal direction and along a second horizontal direction to access objects. The lifting assembly includes four lifting units defining a rectangular area, the four lifting units are respectively arranged in one corner of the rectangular area, the extendable assembly controls the fork to access the objects when the fork is between two adjacent lifting units. The fork includes horizontal arms and a plurality of front forks horizontally spaced apart from each other.

Wherein the stacking crane further includes a supporting platform arranged within the rectangular area, the lifting assembly controls the supporting platform to move along the vertical direction, the rotating assembly is arranged on the supporting platform, the extendable assembly connects to the rotating assembly, and the fork connects to the extendable assembly.

Wherein the four lifting units control the supporting platform to move along the vertical direction simultaneously so that the supporting platform remains horizontally.

Wherein the stacking crane further includes connecting rods for connecting the supporting platform and the lifting assembly.

Wherein when the extendable assembly controls the fork to draw back to be in the rectangular area, the rotating assembly controls the extendable assembly and the fork to rotate in the horizontal surface.

In another aspect, a stacking crane moving along a first horizontal direction includes a lifting assembly, a rotating assembly, an extendable assembly, and a fork. The lifting assembly controls the extendable assembly and the fork to move along a vertical direction, and the rotating assembly rotates the extendable assembly and the fork along a horizontal surface so that the extendable assembly controls the fork to move at least along the first horizontal direction and along a second horizontal direction to access objects.

Wherein the lifting assembly includes four lifting units defining a rectangular area, the four lifting units are respectively arranged in one corner of the rectangular area, the extendable assembly controls the fork to access the objects when the fork is between two adjacent lifting units.

Wherein the stacking crane further includes a supporting platform arranged within the rectangular area, the lifting assembly controls the supporting platform to move along the vertical direction, the rotating assembly is arranged on the supporting platform, the extendable assembly connects to the rotating assembly, and the fork connects to the extendable assembly.

Wherein the four lifting units control the supporting platform to move along the vertical direction simultaneously so that the supporting platform remains horizontally.

Wherein the stacking crane further includes connecting rods for connecting the supporting platform and the lifting assembly.

Wherein the extendable assembly controls the fork to draw back to be in the rectangular area, the rotating assembly controls the extendable assembly and the fork to rotate in the horizontal surface.

Wherein the fork includes horizontal arms and as plurality of front forks horizontally spaced apart from each other.

In another aspect, as stacking crane system includes at least two stacking cranes moving along a first horizontal direction. The two stacking cranes are capable of accessing objects in a second horizontal direction, the second horizontal direction is vertical to the first horizontal direction, and the two stacking cranes transfer the objects to each other in the first horizontal direction.

Wherein each of the stacking crane includes a lifting assembly, a rotating assembly, an extendable assembly, and a fork, the lifting assembly controls the extendable assembly and the fork to move along a vertical direction, and the rotating assembly rotates the extendable assembly and the fork along a horizontal surface so that the extendable assembly controls the fork to move at least along the first horizontal direction and the second horizontal direction to access objects.

Wherein the fork includes horizontal arms and a plurality of front forks horizontally spaced apart from each other when the objects are transferred between the two stacking cranes.

### BRIEF DESCRIPTION OF THE DRAWINGS

FIG. 1 is a vertical view showing the fork in a rectangle area of the stacking crane in accordance with one embodiment.

FIGS. 2A and 2B are vertical views showing the fork of FIG. 1 extending along the first horizontal direction.

FIGS. 3A and 3B are vertical views showing the fork of FIG. 1 extending along the second horizontal direction.

FIG. 4 is a schematic view showing the connection of the stacking cranes.

### DETAILED DESCRIPTION OF THE EMBODIMENTS

Embodiments of the invention will now be described more fully hereinafter with reference to the accompanying drawings, in which embodiments of the invention are shown.

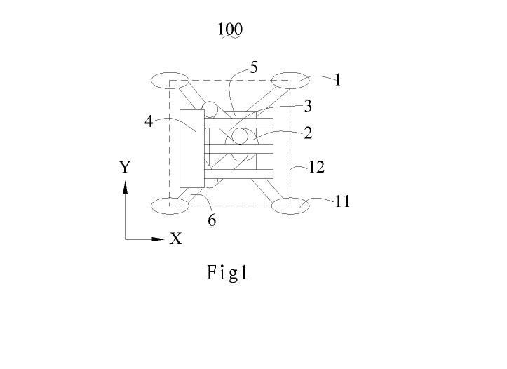

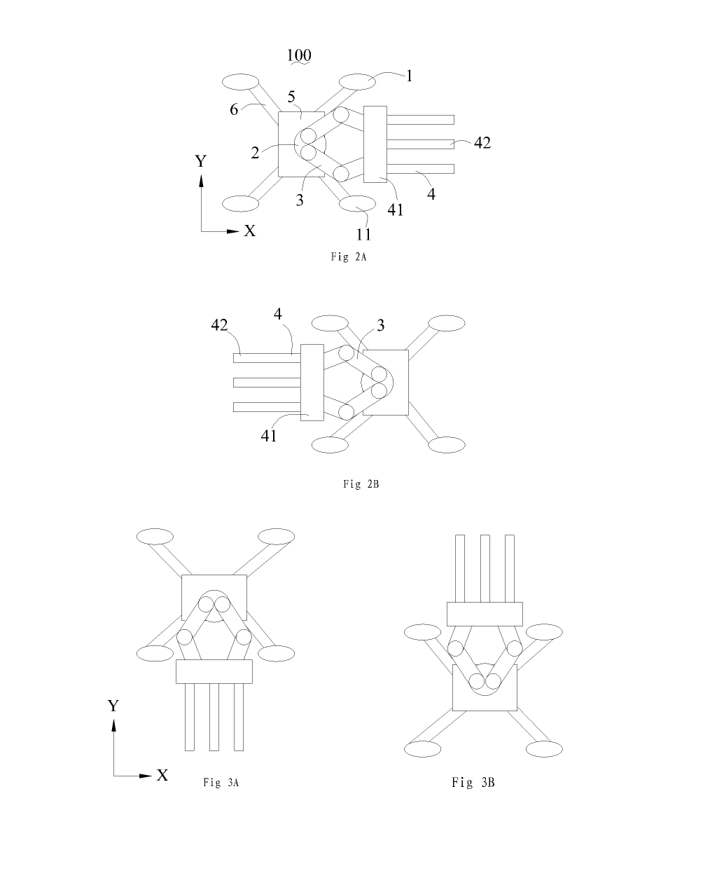

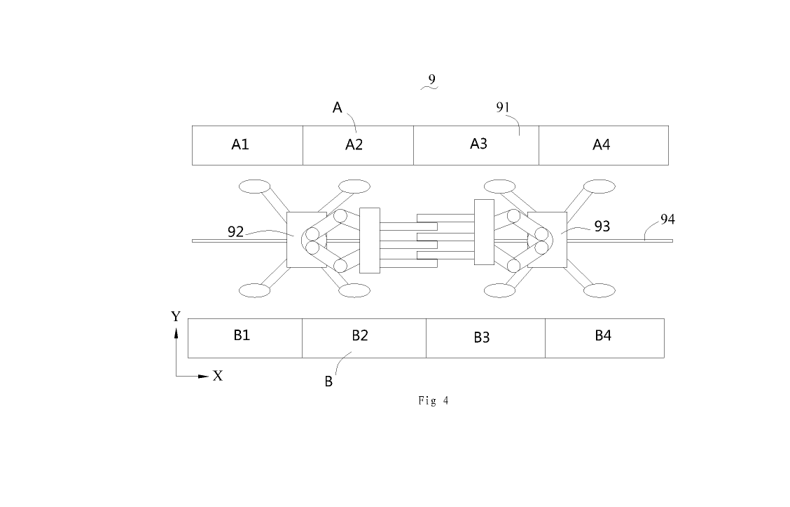

Referring to FIGS. 1 to 3, a stacking crane 100 includes a lifting assembly 1, a rotating assembly 2, an extendable assembly 3, a fork 4, a supporting platform 5, and connecting rods 6. The stacking crane 100 moves along the first horizontal direction X.

The lifting assembly 1 controls the extendable assembly 3 and the fork 4 to move along a vertical direction, and the rotating assembly 2 rotates the extendable assembly 3 and the fork 4 along a horizontal surface. Thus, the extendable assembly 3 may control the fork 4 to move at least along the first horizontal direction X and along a second horizontal direction Y to access objects (not shown), such as a cartridge. The second horizontal direction Y is vertical to the first horizontal direction X.

In the embodiment, the lifting assembly 1 includes four lifting units 11 defining a rectangular area 12. The four lifting units 11 are respectively arranged in one corner of the rectangular area 12.

The supporting platform 5 is arranged within the rectangular area 12. The supporting platform 5 connects to the four lifting units 11 via the four connecting rods 6. The extendable assembly 3 is arranged on the supporting platform 5. The fork 4 connects to the extendable assembly 3 via the rotating assembly 2.

In the embodiment, the extendable assembly 3 is a rod. In other embodiments, the extendable assembly 3 may be other assembly capable of controlling the fork 4 to extend out from the rectangular area 12 or to draw back to be in the rectangular area 12.

The fork 4 is arranged horizontally for accessing the objects. Specifically, the fork 4 includes horizontal arms 41 and a plurality of front forks 42 horizontally spaced apart from each other. The horizontal arms 41 Connect with the extendable assembly 3 and the front forks 42. The horizontal arms 41 and the front forks 42 are substantially rectangular-shaped. In addition, the horizontal arms 41 and the front forks 42 are vertical to each other. Preferably, the horizontal arms 41 extend along the first horizontal direction X or the second horizontal direction Y.

The four lifting units 11 respectively controls the supporting platform 5 to move along the vertical direction via the connecting rods 6 simultaneously, and thus the supporting platform 5 remains horizontally. The rotating assembly 2 on the supporting platform 5, the extendable assembly 3 connecting to the rotating assembly 2, and the fork 4 are moved together with the supporting platform 5 when the supporting platform 5 is moved vertically. In addition, the fork 4 is also horizontally arranged.

When the extendable assembly 3 controls the fork 4 to draw back to be in the rectangular area 12, the rotating assembly 2 controls the extendable assembly 3 and the fork 4 to rotate in the horizontal surface. When the fork 4 is rotated between two lifting units 11, the extendable assembly 3 controls the fork 4 to extend out of the rectangular area 12 so as to access the objects. On the other hand, the fork 4 is not capable of accessing the objects when the fork 4 is not between two adjacent lifting units 11. For example, when the fork 4 faces toward one of the lilting units 11, the fork 4 contacts directly with the lifting units 11 when the fork 4 is extended out of the rectangular area 12. Thus, the fork 4 is not capable of accessing the objects when the fork 4 faces toward the lifting units 11.

In the embodiment, the fork 4 extends along the first horizontal direction X and the second horizontal direction Y via the extendable assembly 3. In other embodiments, the fork 4 may extend along, other directions when a dimension of the fork 4 is smaller than a dimension of the rectangular area 12.

In one embodiment, a stacking crane system 9 includes the stacking crane 100. The stacking crane system 9 includes a warehouse rack 91, stacking cranes 92, 93, and a sliding track 94. The structures of the stacking cranes 92, 93 are substantially the same with the structure of the stacking crane 100.

The warehouse rack 91 includes a first rack A and a second rack B. The first rack A and the second rack B are spaced apart from each other and extend along the first horizontal direction X. The sliding track 94 extends along the first horizontal direction X. In addition, the sliding track 94 is arranged between the first rack A and the second rack B. The stacking cranes 92, 93 moves along the first horizontal direction X on the sliding track 94.

The stacking crane system 9 will now be described by transferring the objects in a storage A1 of first rack A to a storage B4 of second rack B. First, the fork 4 is drew back to be within the rectangular area 12. and the fork 4 and the front forks 42 are rotated to face forward the first rack A. The location of the stacking crane 92 is adjusted along the first horizontal direction X so that the front forks 42 faces forward the first rack A. The height of the lifting units 11 is adjusted until the height of the fork 4 is the same with the height of the objects. The extendable assembly then controls the fork 4 along the second horizontal direction to access the objects in the slot A1.

After the objects are taken out by the stacking crane 92, the fork 4 draws back to be in the rectangular area 12 by controlling the extendable assembly 3. The front forks 42 of the fork 4 faces forward the stacking crane 93 by rotating the rotating assembly 2 and the fork 4 in the horizontal surface. The location of the stacking crane 92 is adjusted along the first horizontal direction X. Alternatively, the locations of the stacking cranes 92, 93 are adjusted along the first horizontal direction X. The forks 4 of the stacking cranes 92, 93 extends out along the first horizontal direction X from respective rectangular area 12 by controlling the extendable assemblies 3 of the stacking cranes 92, 93. At least one of the front forks 42 of the stacking cranes 92, 93 is adjusted by the lifting assemblies 1 of the stacking cranes 92, 93 so that the height of the front forks 42 of the stacking cranes 92, 93 are the same. In this way, the objects may he transferred from the stacking crane 92 to the stacking crane 93. The front forks 42 of the stacking cranes 92, 93 are staggeredly arranged when the objects are transferred therebetween. At least one of the lifting assembly 1 of the stacking cranes 92, 93 is adjusted so that the objects on the front forks 42 of the stacking cranes 92, 93 detaches from the stacking crane 92 and are then received by the stacking crane 93. The stacking crane 93 then stores the objects in the storage B4 by adopting similar mechanisms as above.

The stacking crane is capable of accessing the objects by the fork 4 along the first horizontal direction X and the second horizontal direction Y. The second horizontal direction Y is vertical to the first horizontal direction X. The stacking cranes 92, 93 of the stacking crane system 9 may change the objects directly. As such, not only the transporting efficiency is enhanced, and the capacity of the warehouse system is enhanced for the reason that public areas are not needed.

It is believed that the present embodiments and their advantages will he understood from the foregoing description, and it will he apparent that various changes may be made thereto without departing from the spirit and scope of the invention or sacrificing all of its material advantages, the examples hereinbefore described merely being preferred or exemplary embodiments of the invention.

What is claimed is:

1. A stacking crane moving along a first horizontal direction, comprising:
a lifting assembly, a rotating assembly, an extendable assembly, and a fork;
the lifting assembly controls the extendable assembly and the fork to move along a vertical direction, and the rotating assembly rotates the extendable assembly and the fork along a horizontal surface so that the extendable assembly controls the fork to move at least alone the first horizontal direction and along a second horizontal direction to access objects;
the lifting assembly includes four lifting units defining a rectangular area, the four lifting units are respectively arranged in one corner of the rectangular area the extendable assembly controls the fork to access the objects when the fork is between two adjacent lifting units; and
the fork comprises horizontal arms and a plurality of front forks horizontally spaced apart from each other.

2. The stacking crane as claimed in claim 1, wherein the stacking crane further comprises a supporting platform arranged within the rectangular area, the lifting assembly controls the supporting platform to move along the vertical direction, the rotating assembly is arranged on the supporting platform, the extendable assembly connects to the rotating assembly, and the fork connects to the extendable assembly.

3. The stacking crane as claimed in claim 2, wherein the four lifting units control the supporting platform to move along the vertical direction simultaneously so that the supporting platform remains horizontally.

4. The stacking crane as claimed in claim 2, wherein the stacking crane further comprises connecting rods for connecting the supporting platform and the lifting assembly.

5. The stacking crane as claimed in claim 2, wherein when the extendable assembly controls the fork to draw back to be in the rectangular area, and the rotating assembly controls the extendable assembly and the fork to rotate in the horizontal surface.

6. A stacking crane moving along a first horizontal direction, comprising:
a lifting assembly, a rotating assembly, an extendable assembly, and a fork; and
the lifting assembly controls the extendable assembly and the fork to move along a vertical direction, and the rotating assembly rotates the extendable assembly and the fork along a horizontal surface so that the extendable assembly controls the fork to move at least along the first horizontal direction and along a second horizontal direction to access objects.

7. The stacking crane as claimed in claim 6, wherein the lifting assembly includes four lifting units defining a rectangular area, the four lifting units are respectively arranged in one corner of the rectangular area, and the extendable assembly controls the fork to access the objects when the fork is between two adjacent lifting units.

8. The stacking crane as claimed in claim 7, wherein the stacking crane further comprises a supporting platform arranged within the rectangular area, the lifting assembly controls the supporting platform to move along the vertical direction, the rotating assembly is arranged on the supporting platform, the extendable assembly connects to the rotating assembly, and the fork connects to the extendable assembly.

9. The stacking crane as claimed in claim 8, wherein the four titling units control the supporting platform to move along the vertical direction simultaneously so that the supporting platform remains horizontally.

10. The stacking crane as claimed in claim 8, wherein the stacking crane further comprises connecting sods for connecting the supporting platform and the lifting assembly.

11. The stacking crane as claimed in claim 8, wherein the extendable assembly controls the fork to draw hack to he in the rectangular area, and the rotating assembly controls the extendable assembly and the fork to rotate in the horizontal surface.

12. The stacking crane as claimed in claim 6, wherein the fork comprises horizontal arms and a plurality or front forks horizontally spaced apart from each other.

13. A stacking crane system, comprising:
at least two stacking cranes move along a first horizontal direction, the two stacking cranes are capable of accessing objects in a second horizontal direction, the second horizontal direction is vertical to the first horizontal direction, and the two stacking cranes transfer the objects to each other in the first horizontal direction.

14. The stacking crane system as claimed in claim 13, wherein each of the stacking crane comprises a lifting assembly, a rotating assembly, an extendable assembly, and a fork, the lifting assembly controls the extendable assembly and the fork to move along a vertical direction, and the rotating assembly rotates the extendable assembly and the fork along a horizontal surface so that the extendable assembly controls the fork to move at least along the first horizontal direction and the second horizontal direction to access objects.

15. The stacking crane system as claimed in claim 14, wherein the fork comprises horizontal arms and a plurality of front forks horizontally spaced apart from each other when the objects are transferred between the two stacking cranes.
